(19) United States
(12) Patent Application Publication
(10) Pub. No.: US 2008/0204313 A1
(43) Pub. Date: Aug. 28, 2008

(54) Radio Navigation Satellite System Wall Power Automatic Timer

(76) Inventors: Gregory C. Petrisor, Los Angeles, CA (US); Ryan A. Perdue, Venice, CA (US)

Correspondence Address: Scot A Reader, 1320 Pearl Street, Suite 228, Boulder, CO, 80302, US

(21) Appl. No.: 11/793,885

(22) PCT Filed: Nov. 13, 2006
(86) PCT No.: PCT/US2006/044109

§ 371 Date: Jun. 21, 2007

Related U.S. Application Data
(60) Provisional application No. 60/740,714, filed on Nov. 30, 2005.

(51) Int. Cl. G01S 1/00

(52) U.S. Cl. 342/357.06

(57) ABSTRACT

A radio navigation satellite system (RNSS) automatic timer for regulating a flow of wall power is adapted to determine time and position information based at least in part on signals received from RNSS satellites, determine an operational state as a function on the time and position information and regulate a flow of power from a wall power source as a function of the operational state. Through judicious integration of a RNSS receiver into an automatic timer, the need for a user to enter time, date, and position information is advantageously reduced or eliminated outright. The need for a backup battery to maintain the clock state in the event of a power failure is also eliminated.

### CROSS REFERENCE TO RELATED APPLICATION

This application claims priority to U.S. Provisional Patent Application Ser. No. 60/740,714 entitled “Radio Navigation Satellite System Wall Power Automatic Timer,” filed Nov. 30, 2005, the disclosure of which is incorporated herein by reference.

### BACKGROUND OF THE INVENTION

The present invention relates to an improved automatic timer for wall-powered applications, and more particularly to a radio navigation satellite system (RNSS) automatic timer adapted to regulate the supply of wall power.

Automatic timers are used in households, businesses and institutions to automatically operate wall-powered electrical appliances, lighting, sprinklers, and so on. One type of automatic timer is used as a substitute for a conventional electric wall switch. This type of automatic timer replaces a conventional wall switch with a timer that has an ability to automatically operate whatever had been previously operated by the wall switch and thus the timer actually controls the wall power to the system or device. Thus, if the conventional wall switch had been used to operate an electrical outlet, the automatic timer can be programmed to automatically turn on and off whatever is plugged into the outlet. Likewise, if the conventional wall switch had been used to turn on a lighting fixture, the automatic timer can be programmed to automatically turn on and off the lighting fixture. A second type of automatic timer plugs-in to an electrical outlet and can be programmed to automatically turn on and off one or more wall power sockets. A third type of automatic timer is used in systems in which the automatic timer switches or modulates converted wall power (typically converted to DC power) to a remote system, subsystem or device such as sprinkler control system. In this type of system, the automatic timer automatically turns on and off sprinklers generally based on time of day. A fourth type of automatic timer is used in self-contained applications to switch wall power or to switch or modulate converted wall power internally to operate subsystems of the application such as an alarm clock. In this type of system, the automatic timer automatically turns on the alarm based on time of day.

As electronics become more miniaturized, it is possible to provide more features and greater functionality in automatic timers, including multiple ON/OFF times, varying ON/OFF times, ON/OFF times relative to sunrise or sunset, etc. However, including such features in an automatic timer can complicate programming, operation and maintenance of the timer by the user. As an automatic timer is provided with more features and greater functionality, it becomes desirable to simplify automatic timer configuration requirements where possible. In addition, in order to maintain the clock state in the event of a power failure, many automatic timers require a battery which complicates maintenance and is not environmentally friendly. It is therefore desirable to reduce where possible the need for user programming, operation (and maintenance and eliminate the need for a battery to maintain the clock state in automatic timers adapted to regulate the supply of wall power.

Meanwhile, it is known to use RNSS receivers, such as global positioning system (GPS) receivers, to regulate the supply of locally generated power in mobile applications. In these mobile applications, the GPS receiver has a non-static location, that is, the receiver moves as part of the application. The primary value of the GPS receiver in these mobile applications is determining location and/or velocity in a timely fashion, such as for navigation or surveying. Several requirements are therefore of primary importance to these mobile applications, including time to first fix, location accuracy and velocity accuracy. Providing an accurate clock and/or accurate frequency is of generally lesser importance.

Capurka et al. U.S. Pat. No. 5,247,440, for example, addresses automated control of a transportation vehicle's lights. This patent targets moving vehicles and lighting control is accomplished by regulating vehicle power to the lights based on location and time of day information received from an RNSS or other wireless communication system. The location information used for the lighting control system is provided from the vehicle's GPS-based navigation system. This patent is adapted to a mobile application and the power controlled based on the GPS input is locally generated vehicle power.

Habu et. al. Japanese Patent Application Publication No. 2000-9821A describes a backlight control system for an LCD display of a handheld GPS receiver in which the backlight of the LCD used to display location and time information from the GPS receiver is switched on and off based on computed day and night time zones in order to extend the life of the LCD display. This patent application describes a mobile GPS device with local battery power being controlled by GPS inputs.

Ui Japanese Patent Application Publication No. 2000-292198A describes a back light control system for an on-vehicle navigation system in which the display brightness is set according to the vehicle's location and the local time of day. This patent application is adapted for a moving vehicle's navigation system and the power controlled by the GPS signals is the vehicle's locally generated power.

Williams et al. U.S. Pat. No. 6,753,842 provides a system and method for controlling the backlight of a wireless handset based on its location and the local time of day derived from a GPS receiver along with the output of a photo sensor. A stated goal is enabling the reduction of power consumption and thus conservation of battery energy. The patent is targeted for a wireless communication device which is a mobile application and the power control of the backlight is local battery power.

Automatic timers are also known for static applications. However, these timers are not known to use an RNSS receiver to regulate the supply of wall power, for example.

### SUMMARY OF THE INVENTION

The present invention, in a basic feature, comprises an automatic timer having a RNSS receiver, such as a GPS receiver, and adapted to control wall power, and methods therefor. When powered up, the automatic timer computes time, date, and position information based on information received by the RNSS receiver. In the event of a power disruption, the automatic timer automatically re-computes such information upon resumption of power. Through judicious integration of an RNSS receiver into an automatic timer, the need for a user to enter into the automatic timer time, date, and position information is advantageously reduced or eliminated outright. The need for a backup battery to maintain the clock state in the event of a power failure is also eliminated. Moreover, due to the static disposition of the RNSS receiver and the fact that it is the ability to produce an accurate clock that is of primary importance, logic requirements for the RNSS receiver of the present invention are advantageously reduced relative to RNSS receivers for mobile applications. A main requirement of the RNSS receiver of the present invention is high sensitivity to enable indoor reception. The fact that the receiver is static in its location enables additional degrees of freedom for increasing sensitivity of the RNSS receiver. Meanwhile, several requirements important to RNSS receivers for mobile applications, such as time to first fix, location accuracy and velocity accuracy, have decreased significance that substantially reduces logic requirements for the RNSS receiver of the present invention.

An automatic timer in one embodiment of the present invention comprises an RNSS receiver, a power controller adapted to regulate a flow of power from a wall power source based on an operational state and a state controller operatively coupled to the RNSS receiver and the power controller and adapted to control the operational state based at least in part on information received from the RNSS receiver. The RNSS receiver may be a GPS receiver. The power controller may be an AC or DC controller or switch. The automatic timer may be, for example, a wall power outlet timer wherein the power controller is adapted to regulate the flow of power to one or more outlets, a light timer wherein the power controller is adapted to regulate the flow of power to one or more or light fixtures, a sprinkler timer wherein the power controller is adapted to regulate the flow of power to one or more sprinkler systems, a climate control timer wherein the power controller is adapted to regulate the flow of power to one or more climate control units, or a tethered device timer wherein the power controller is adapted to regulate a flow of power to a household device such as a power strip, oven range, coffee maker or alarm clock, that during operation remains tethered with a cord to an wall-powered outlet. The state controller may notify the power controller of the operational state by issuing one or more commands to the power controller. The commands issued by the controller may include one or more “on”, “off” or power level commands generated based at least in part on information received from the RNSS receiver, in response to which the power controller permits the flow of power, inhibits the flow of power or regulates the power level.

These and other aspects of the invention will be better understood by reference to the following detailed description taken in conjunction with the drawings that are briefly described below.

### BRIEF DESCRIPTION OF THE DRAWINGS

FIG. 1 shows in-wall RNSS wall power automatic timers adapted for light fixture and outlet power regulation in one embodiment of the invention.

FIG. 2 shows a power cord tethered RNSS wall power automatic timer in another embodiment of the invention.

FIG. 3 shows a power cord tethered RNSS direct current automatic timer in another embodiment of the invention.

FIG. 4 shows an embedded RNSS AC/DC automatic timer in another embodiment of the invention.

FIG. 5 is a flow diagram describing functions performed by an RNSS automatic timer in one embodiment of the invention.

### DETAILED DESCRIPTION OF A PREFERRED EMBODIMENT

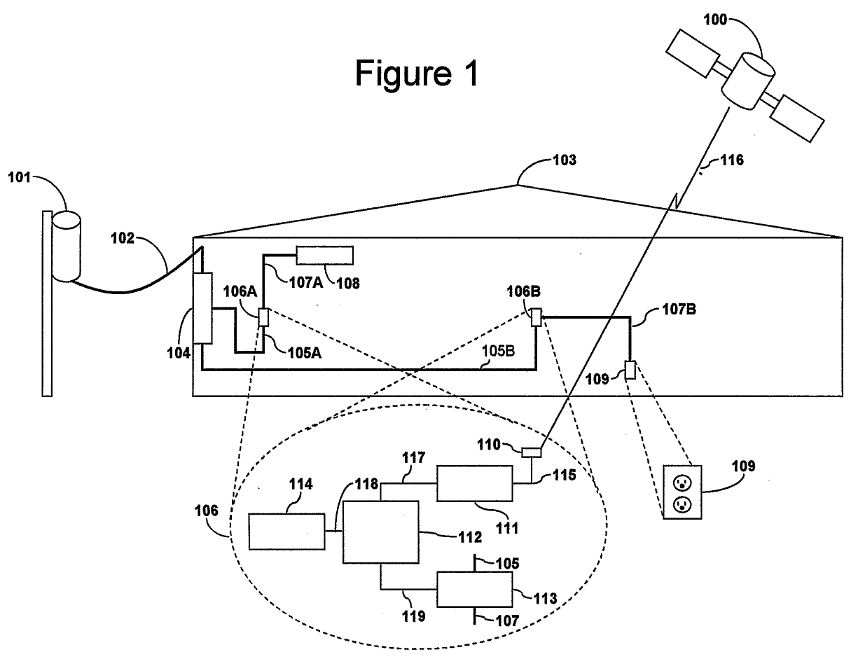

FIG. 1 shows in-wall RNSS wall power automatic timers 106A, 106B for use in controlling a light fixture 108 and a wall power outlet 109 in one embodiment of the invention. The RNSS components described herein may be GPS components. Timers 106A, 106B are connected to an electric panel 104 of a building 103 through branch circuit conductors 105A, 105B, which may be daisy chained through one or more switches to reach electrical panel 104. Building 103 may be a residential or commercial structure, Electrical panel 104 connects to a transformer drum 101 through a service conductor 102. In the figure, one timer 106A connects to light fixture 108 through a switch-leg component of a branch service conductor 107A and a second timer 106B connects to outlet 109 through a switch-leg component of a branch service conductor 107B. A representative one of timers 106 contains a RNSS antenna 110 which receives signals 116 from RNSS satellites 100. RNSS antenna 110 is coupled to an RNSS receiver 111 through an antenna coupling conductor 115. A state controller 112 receives position and time information from RNSS receiver 111 through RNSS receiver interface 117. State controller 112 may also receive inputs from a user system 114 through a user system interface 118. User system 114 may include, for example, an electronic keypad and display or a series of levers that can be toggled manually. State controller 112 periodically determines an operational state for timer 106 by applying active power regulation policies to inputs from RNSS receiver 111 and any inputs from user system 114. State controller 112 sends commands indicating the operational state to wall power switch 113 through a wall power switch interface 119 causing wall power switch 113 to configure itself based on the indicated operational state. In some embodiments, state controller 112 maintains information on the current operational state in memory for comparison with the periodically determined operational state and sends commands to switch 113 only when the operational state has changed. Switch 113 regulates the power delivered from the electrical panel side of a branch circuit conductor 105 to the switch-leg component 107 of a branch circuit conductor based its configuration. For example, an “on” command causes switch 113 to self-configure to an “on” state wherein the flow of power is permitted whereas an “off” command causes switch 113 to self-configure to an “off” state wherein the flow of power is inhibited.

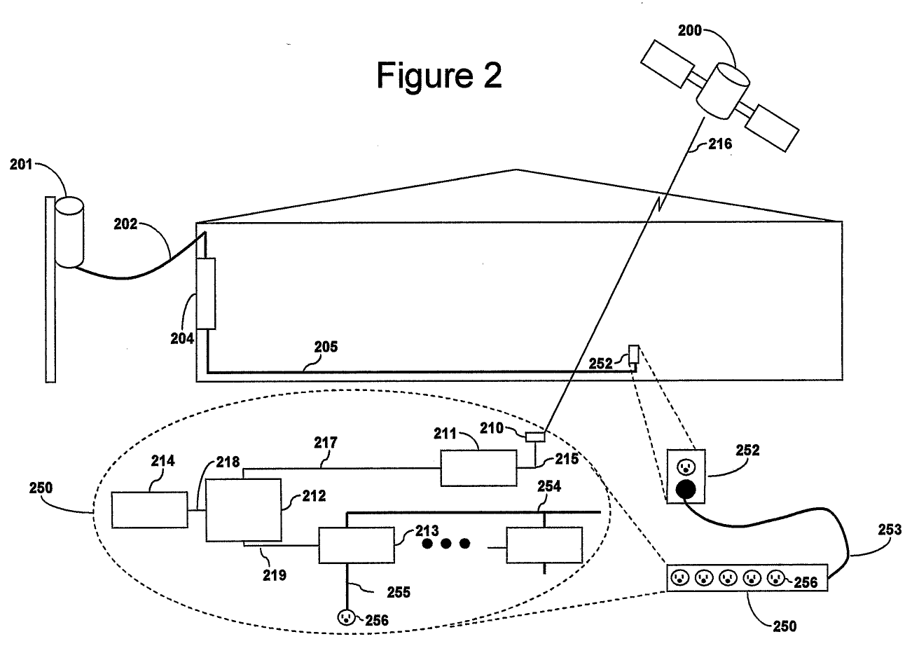

FIG. 2 shows a power cord tethered RNSS wall power automatic timer 250 in another embodiment of the invention. In this embodiment, timer 250 is connected to a wall power outlet 252 using an external power cord 253. Power is delivered to outlet 252 through a branch circuit conductor 205 which connects to a building electric panel 204 directly or via one or more daisy chain connections. Power is delivered to electric panel 204 through a service conductor 202 that connects to a transformer drum 201. Timer 250 contains an RNSS antenna 210 which receives signals 216 from RNSS satellites 200. RNSS antenna 210 is coupled to an RNSS receiver 211 through an antenna-coupling conductor 215. A state controller 212 receives position and time information from RNSS receiver 211 through an RNSS receiver interface 217. State controller 212 may also receive inputs from a user system 214 through a user system interface 218. User system 214 may include, for example, an electronic keypad and display or a series of levers that can be toggled manually. State controller 212 periodically determines the operational state of one or more wall power switches 213 by applying active power regulation policies to inputs from RNSS receiver 211 and any inputs from user system 214. State controller 212 sends commands indicative of operational state to switches 213 through wall power switch interfaces 219 causing switches 213 to configure themselves based on the indicated operational state. Switches 213 may configure switch states independently of one another based on commands targeted for individual switches. Timer 250 has sockets 256 that receive wall power from switched power lines 255 and switches 213 regulate power delivered from an internal power cord 254 to switched power lines 255 based on their configuration. Internal power cord 254 connects through the side of timer 250 to external power cord 253 and receives power thereover.

State controllers 112, 212 are configured with power regulation policies. Power regulation policies may be implemented using software, firmware or circuitry and may include, for example, a “dusk-to-dawn” variant for security applications in which a wall-powered application may be preconfigured to turn on at dusk and off at dawn and a ‘business day’ variant in which a wall-powered application remains on during business hours, for example, from 7:00 a.m. to 9:00 p.m., Monday-Friday, or alternatively during non-daylight business hours. Power regulation policies may be configured by the manufacturer or in the field through inputs on user systems 114, 214, for example. Power regulation policies may be rendered active or inactive through inputs on user systems 114, 214.

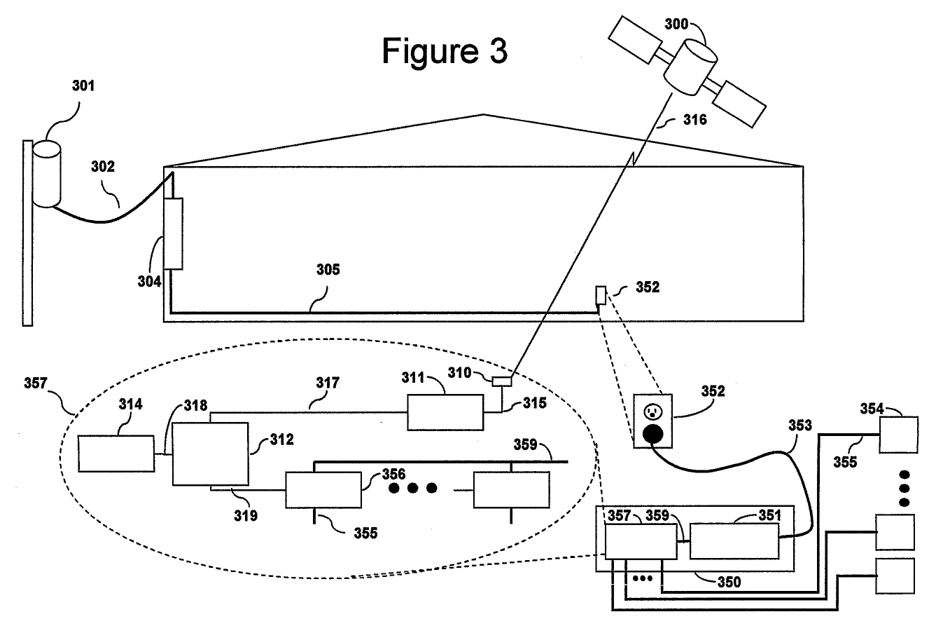

FIG. 3 shows a power cord tethered RNSS direct current automatic timer 350 in yet another embodiment of the invention. In this embodiment, timer 350 is connected to a wall power outlet 352 with an external power cord 353. Power is delivered to outlet 352 through a branch circuit conductor 305 which connects to a building electric panel 304 directly or via one or more daisy chain connections. Power is delivered to electric panel 304 through a service conductor 302 that connects to a transformer drum 301. Timer 350 has timer logic 357 including an RNSS antenna 310 which receives signals 316 from RNSS satellites 300. RNSS antenna 310 is coupled to an RNSS receiver 311 through an antenna-coupling conductor 315. A state controller 312 receives position and time information from RNSS receiver 311 through an RNSS receiver interface 317. State controller 312 may also receive inputs from a user system 314 through a user system interface 318. State controller 312 periodically determines an operational state for one or more DC power controllers 356 by applying active power regulation policies to inputs from RNSS receiver 311 and any inputs from user system 314. State controller 312 sends commands indicating the operational state to one or more DC power controllers 356 through one or more DC power controller interfaces 319 causing one or more DC power controllers 356 to configure themselves to the indicated operational state. Power controllers 356 may configure operational states independently of one another based on commands targeted for individual power controllers. DC power controllers 356 receive converted wall power (DC power) from power converter 351 over internal DC power line conductor 359 and output modulated DC power over DC power output conductors 355. DC power converter 351 converts wall power received from power cord 353 into DC power. One or more controlled DC power output conductors 355 are connected to and power one or more DC powered devices 354.

State controller 312 is configured with power regulation policies. Power regulation policies may be implemented using software or firmware and may include, for example, a sprinkler timing variant in which different sprinkler groups may be preconfigured to turn on and off on particular days and at particular times. Power regulation policies may be configured by the manufacturer or in the field through inputs on user systems 314, for example. Power regulation policies may be rendered active or inactive through inputs on user systems 314.

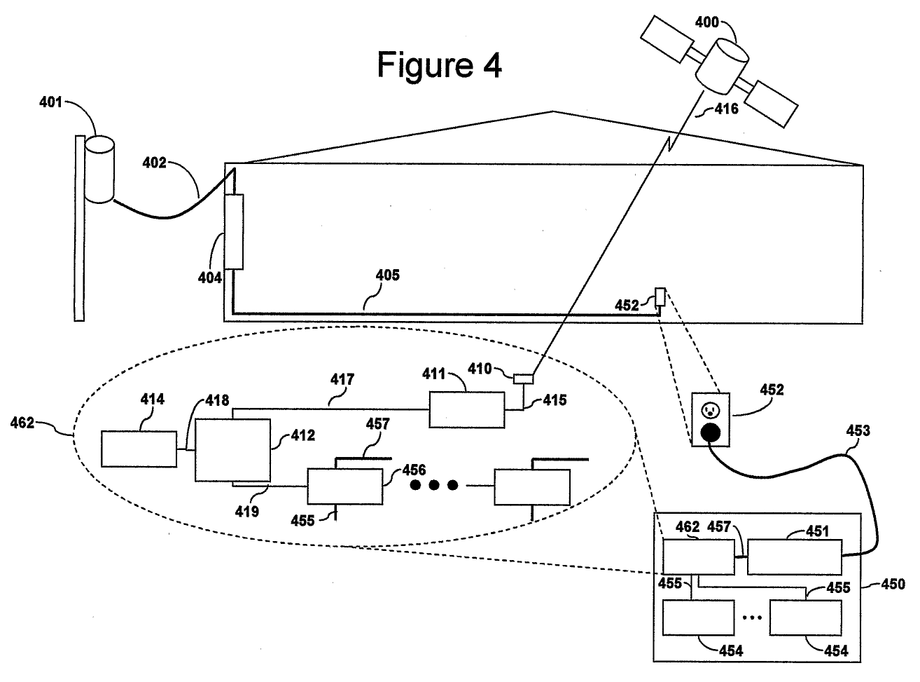

FIG. 4 shows an embedded RNSS AC/DC automatic timer 462 in yet another embodiment of the invention. In this embodiment, timer 462 is embedded within a power cord tethered system or appliance 450 which is connected to a wall power outlet 452 via a power cord 453. Power is delivered to outlet 452 through a branch circuit conductor 405 which connects to a building electric panel 404 directly or via one or more daisy chain connections. Power is delivered to electric panel 404 through a service conductor 402 that connects to a transformer drum 401. Power converter 451 converts wall power (typically AC power) received from power cord 453 to DC power which is output over an internal DC power conductor 457. Timer 462 receives DC power through internal DC power conductor 457 which connects to power converter 451. In other embodiments, timer 462 may accept wall power via direct connection to power cord 453. Timer 462 has an RNSS antenna 410 which receives signals 416 from RNSS satellites 400. RNSS antenna 410 is coupled to an RNSS receiver 411 through an antenna-coupling conductor 415. A state controller 412 receives position and time information from RNSS receiver 411 through RNSS receiver interface 417. State controller 412 may also receive inputs from a user system 414 through a user system interface 418. State controller 412 periodically determines an operational state for one or more power controllers 456 by applying active power regulation policies to inputs from the RNSS receiver 411 and any inputs from user system 414. State controller 412 sends commands indicating the operational state to one or more power controllers 456 through one or more power controller interfaces 419 that causes power controllers 456 to configure themselves based on the indicated operational state. Power controllers 456 receive DC power through internal DC power conductor 457 which connects to power converter 451 and output modulated DC power over power outputs 455. In other embodiments, power controllers 456 may accept wall power over a direct connection to power cord 453 and output modulated AC power over power outputs 455. One or more power outputs 455 are connected to one or more powered devices 454 that are adapted to receive the modulated DC or AC power.

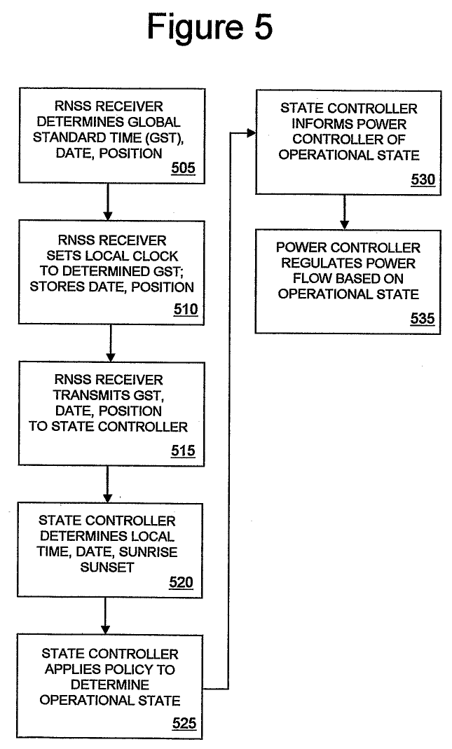

In FIG. 5, a flow diagram describing functions performed by an RNSS automatic timer in one embodiment of the invention is provided. An RNSS receiver determines global standard time (GST), date and position from RNSS satellite signals (505). Acquisition of RNSS signals and determination of GST, date and position is made upon power-up of the timer and periodically thereafter when RNSS satellite signals are available. The RNSS receiver sets or resets its internal clock to the determined GST and stores the date and position (510). Internal clock reset corrects any drift that occurs while the clock runs freely between GST determinations. The RNSS receiver transmits its current internal clock GST time and the current stored date and position to a state controller (515). Such transmission is performed periodically. The state controller determines the local time, local date, local sunrise time and local sunset time using the GST, date and position received from the RNSS receiver (520). In making the local time determination, the state controller in some embodiments resolves the position to a time zone and references an internal time zone/daylight savings time calendar to account for daylight savings time. Local time and date determinations are performed periodically. The state controller applies an active time-based power regulation policy in conjunction with one or more of the local time, local date, local sunrise and local sunset to determine an operational state of timer, for example, “on” or “off” (525). The state controller thereafter notifies a power controller of the operational state (530). Such notification may be made through the issuance to the power controller of a command indicative of the operational state. In some embodiments, the state controller compares the current operational state with the previously determined operational state stored on the state controller and notifies the power controller only if the operational state has changed. In response to notification of the operational state, the power controller regulates the flow of power from a wall power source in accordance with the operational state (535). Thus, for example, if the operational state is “on”, the power controller permits the flow of power from the wall power source; if the operational state is “off”, the power controller inhibits the flow of power from the wall power source.

The RNSS receiver functions, state controller functions and power controller functions described herein may be implemented in custom logic, such as ASICs, general purpose logic, such as software programs implemented by general purpose processors, firmware, or a combination thereof.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

1. An automatic timer for regulating a flow of wall power, comprising:
a radio navigation satellite system (RNSS) receiver adapted to receive first time information;
a state controller communicatively coupled with the RNSS receiver adapted to receive from the RNSS receiver second time information and determine an operational state based at least in part on the second time information; and
a power controller communicatively coupled with the state controller adapted to receive from the state controller operational state information and regulate a flow of power from a wall power source based at least in part on the operational state information.

2. The automatic timer of claim 1, wherein the state controller is further adapted to receive additional information from a user system and determine the operational state based at least in part on the additional information.

3. The automatic timer of claim 1, wherein the state controller is configured with a time-based power regulation policy and is further adapted to determine the operational state based at least in part on the policy.

4. The automatic timer of claim 1, wherein the state controller determines a local time based at least in part on the second time information and determines the operational state based at least in part on the local time.

5. The automatic timer of claim 4, wherein the second time information includes global standard time information and the state controller determines the local time based at least in part on the global standard time information and position information received from the RNSS receiver.

6. The automatic timer of claim 1, wherein the RNSS receiver comprises a global positioning system (GPS) receiver.

7. The automatic timer of claim 1, wherein the power controller comprises an AC switch.

8. The automatic timer of claim 1, wherein the power controller comprises a DC switch.

9. The automatic timer of claim 1, wherein the power controller is adapted to regulate the flow of power to one or more wall power outlets.

10. The automatic timer of claim 1, wherein the power controller is adapted to regulate the flow of power to one or more or light fixtures.

11. The automatic timer of claim 1, wherein the power controller is adopted to regulate the flow of power to one or more sprinkler systems.

12. The automatic timer of claim 1, wherein the power controller is adopted to regulate the flow of power to one or more climate control units.

13. The automatic timer of claim 1, wherein the power controller is adapted to regulate the flow of power to a device that during operation remains tethered with a cord to a wall power outlet.

14. A method for regulating a flow of wall power, comprising:
determining time and position information based at least in part on signals received from RNSS satellites;
determining an operational state as a function of the time and position information; and
regulating a flow of power from a wall power source as a function of the operational state.

15. The method of claim 14, further comprising the steps of determining a local time as a function of the time and position information and determining the operational state as a function of the local time.

16. The method of claim 14, further comprising the steps of determining at least one of a local sunrise time and local sunset time as a function of the time and position information and determining the operational state as a function of at least one of the local sunrise time and local sunset time.
